(19) United States
(12) Patent Application Publication
(10) Pub. No.: US 2023/0352878 A1
(43) Pub. Date: Nov. 2, 2023

(54) DEVICE FOR SECURING A CONNECTION OF A CONNECTING TIP WITH A COMPLEMENTARY RECEIVER OF A MOBILE DEVICE

(71) Applicant: Stéphane OLIVIER, Asnieres-sur-Seine (FR)

(72) Inventor: Stéphane OLIVIER, Asnieres-sur-Seine (FR)

(21) Appl. No.: 18/005,987

(22) PCT Filed: Jul. 21, 2021
(86) PCT No.: PCT/FR2021/051360

§ 371 Date: Jan. 19, 2023

(30) Foreign Application Priority Data
Jul. 21, 2020 (FR) FR2007667

(51) Int. Cl. H01R 13/639; H01R 13/512; H01R 13/622

(52) U.S. Cl. CPC H01R 13/639; H01R 13/512; H01R 13/622

(57) ABSTRACT

The device for securing a connection of a connecting tip to a complementary connecting receiver of a mobile device includes a first element arranged so as to be securely attached in a detachable manner onto the mobile device in the vicinity of the connecting receiver, and a second element arranged so as to be securely attached to the connecting tip, the securing device further including secure means for assembling the first and second elements to one another, when a connection is made between the tip and the receiver.

### TECHNICAL FIELD OF THE INVENTION

The invention relates to a device for securing a connection of a connection tip with a complementary connection receiver of a mobile device. In particular, the mobile device can be a professional digital camera, a portable music player or any other device that can be easily moved around for which a securing of the connection is necessary or desirable.

### STATE OF THE ART

Currently, in a particular and illustrative application of a digital camera, there are situations in which the digital camera is subject to serious manipulation.

A first problem arises from the fact that the size of the digital files of the photos which are produced by such a mobile device, for example in a fashion or advertising shooting session, is such that it is not possible for all of them to be stored in an internal memory of the digital camera. Because of this, the user is obliged to transfer them directly and in real time to a computer situated away from the shooting space and linked to the digital camera by a data transfer cable, for example a USB (universal serial bus) cable.

A second problem arises from the fact that the photographer prefers not to use a memory card or/and to be able to view the photos taken in sequence on a remote computer comprising image capture software and a display screen much bigger than that incorporated in the digital camera and directly connected thereto via a data transfer cable, such as a USB cable. That makes it possible not only to view the acquired photos immediately, but also to proceed with filing, exporting, and enhancements, including the colorimetry and curves. It is therefore easy to have access very rapidly to the images on the remote computer, without having to remove the memory card from the digital camera, then place it in a card reader suitable for accessing said images. That provides a certain convenience in the shooting process and a certain fluidity in the procedure.

Consequently, the user of the digital camera during the shoots runs a strong risk of disconnecting the data transfer cable from the mobile device inadvertently, accidentally, thus ruining the current shooting session. The digital camera manufacturers offer an accessory that makes it possible to maintain the connection between the data transfer cable and the digital device. However, the arrangement of these accessories does not make it possible to reliably and durably ensure the connection while the digital camera is being manipulated for numerous shots that are all in a day's work for a professional user when conducting a fashion or advertising campaign.

It is therefore necessary to provide a device for securing such a connection between a data transfer cable and a digital camera, or any other mobile device subject to numerous manipulations, which is reliable and simple to use.

### SUMMARY OF THE INVENTION

One aim of the invention is therefore to provide such a connection device which does not present the drawbacks previously cited and which makes it possible to ensure, in time, a reliable and durable connection while being very simple to use.

To this end, according to the invention, a device is provided for securing a connection of a connection tip with a complementary connection receiver of a mobile device, the device comprising a first element arranged so as to be secured removably on the mobile device in the vicinity of the connection receiver, and a second element arranged so as to be secured to the connection tip, the securing device further comprising means for the secured assembly of the first and second elements with one another, when a connection is made between the tip and the receiver.

Advantageously, but optionally, the securing device according to the invention has at least one of the following technical features:
one of the first and second elements comprises a groove for receiving all or part of the other of the first and second elements;
the other of the first and second elements comprises a protuberance of a form complementing a form of the receiving groove;
the secured assembly means comprise a locking pin;
the locking pin is arranged so as to pass through the receiving groove; and
the locking pin is arranged so as to pass through the protuberance of complementary form.

Also provided, according to the invention, is a connecting cable comprising a connection tip comprising the second element of the securing device having at least one of the preceding technical features positioned on the connection tip.

Advantageously, but optionally, the connecting cable according to the invention has at least one of the following technical features:
the second element is overmolded on the connection tip; and
the second element forms the connection tip, being made of a piece therewith.

Finally, according to the invention, a secured connection kit is provided comprising a cable comprising a connection tip, and the securing device having at least one of the preceding technical features, the second element being mounted on the connection tip.

Advantageously, but optionally, the connection kit according to the invention offers at least the fact that the cable has at least one of the preceding features.

### BRIEF DESCRIPTION OF THE FIGURES

Other features and advantages of the invention will emerge on reading the following description of an embodiment of the invention. In the attached drawings:

FIG. 1 is a three-dimensional view of an embodiment of a securing device according to the invention;

FIG. 2 is a three-dimensional view of a second element of the securing device of FIG. 1;

FIG. 3 is a three-dimensional view of a first element of the securing device of FIG. 1, capable of cooperating with the second element of FIG. 2;

FIG. 4 is a top view of the first element of FIG. 3;

FIG. 5 is a three-dimensional view of a cap of the second element of FIG. 2;

FIG. 6a and

FIG. 6b are three-dimensional views from two different angles of a support of the second element of FIG. 2;

FIG. 7 is a top view of the securing device of FIG. 1, without the second element;

FIG. 8a and

FIG. 8b are top and partial cross-section views of a locking broach of the securing device according to the invention.

For greater clarity, the elements that are identical or similar are identified by identical reference symbols throughout the figures.

### DETAILED DESCRIPTION OF AN EMBODIMENT

Referring to FIG. 1, there now follows a description of a device for securing a connection 1 according to the invention of a connection tip. The device for securing a connection 1 according to the invention comprises a first element 10 and a second element 20 which are securely and reversibly assembled with one another. Also, the device for securing a connection 1 according to the invention comprises a locking broach 30 forming means for the secured assembly of the first 10 and second 20 elements with one another, when a connection is made between the connection tip and a mobile device.

The locking broach 30 forming the means for the secured assembly of the first 10 and second 20 elements of the device for securing a connection 1 according to the invention comprise, at a first end, a locking pin 31 and, at an opposite end, a free end 32 for manipulation comprising an axially protruding mobile unlocking control button 33. The locking broach 30 will be described in more detail later in the description.

Finally, the device for securing a connection 1 according to the invention comprises means 40 for fixing the first element 10 onto a mobile device comprising a connection receiver complementing the connection tip for which the device for securing a connection 1 according to the invention is intended to durably and simply make the connection that can be made between the connection tip and the abovementioned connection receiver reliable and secure.

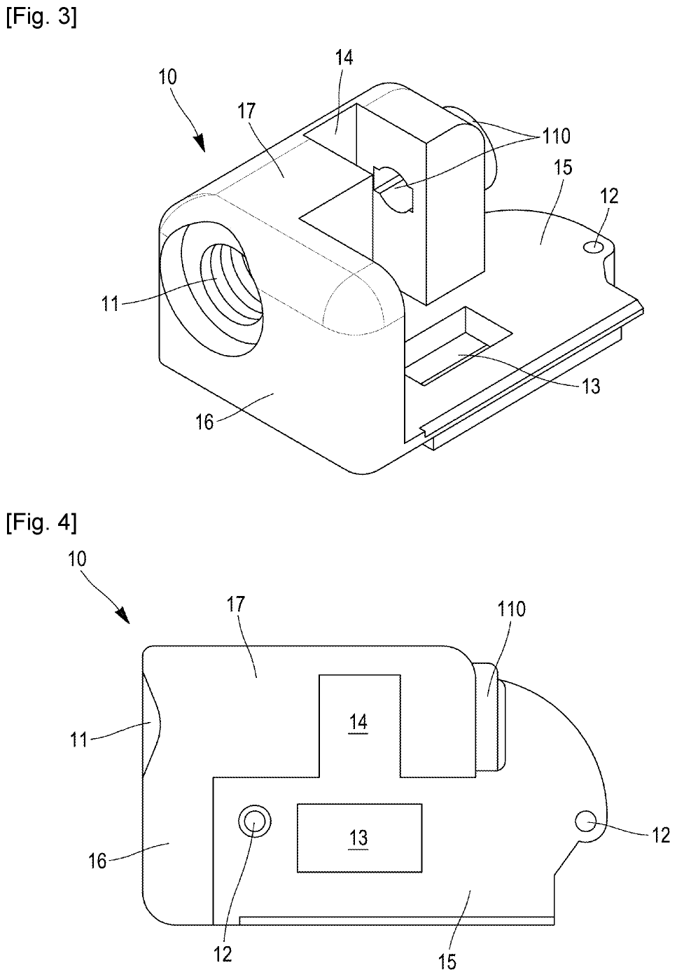

Referring to FIGS. 3 and 4, there now follows a more detailed description of the first element 10 of the device for securing a connection 1 according to the invention.

The first element 10 comprises a plate 15 comprising, on the one hand, a through-hole 13, the form of which is arranged and chosen so as to allow a protruding and useful part of the connection tip to pass. Also, once the first element 10 is removably secured, via the means 40 for fixing onto the mobile device, the through-hole 13 comes opposite and surrounds the connection receiver of the mobile device to which the first element 10 is removably secured. Also, the plate 15 comprises a set of fixing holes 12 through which the means 40 for fixing the first element 10 onto the mobile device pass.

The first element 10 comprises, in addition, a guiding wall 17 in which is formed a receiving groove 14. An introduction orifice 11 is formed through the guiding wall 17 longitudinally in its thickness in such a way that the introduction orifice 11 “extends” through the receiving groove 14 and is continued by a receiving orifice 110. The introduction orifice 11 and the receiving orifice 110 are intended to slidingly and lockingly receive the locking broach 30. In particular, the introduction orifice 11 is, here, threaded and receives the locking pin 31 comprising complementary threading. Also, the receiving orifice 110 slidingly receives at least a part of the free manipulation end 32, of the locking broach 30. The receiving groove 14 is formed so as to be oriented in the same way as the passage 13 produced in the plate 15 of the first element 10.

Furthermore, the first element 10 comprises a lateral wall 16 formed at right angles to the guiding wall 17. The lateral 16 and guiding 17 walls extend protrudingly from a top face of the plate 15. These walls serve to guide, when it is put in place, the second element 20 described in more detail below, and to protect it before the locking broach 30 is put in place.

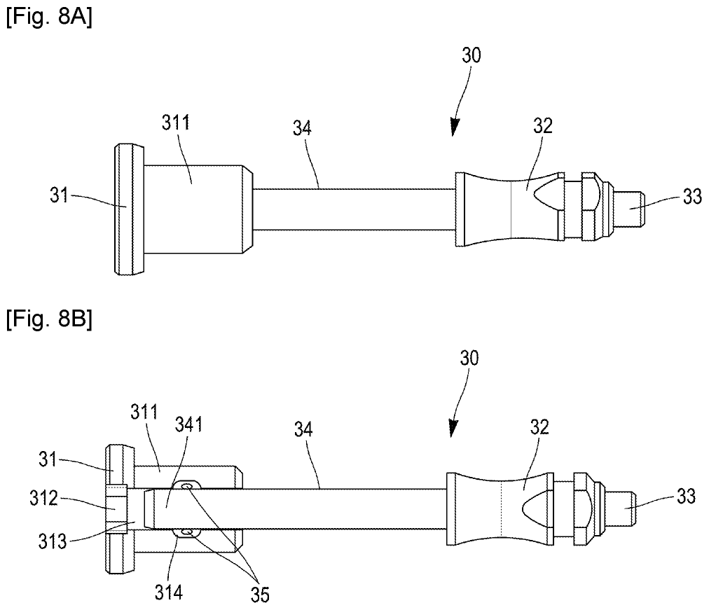

Referring to FIGS. 7, 8a and 8b, there now follows a more detailed description of a preferred embodiment of said locking broach 30 of the device for securing a connection 1 according to the invention. The locking broach 30 further comprises a stem 34 comprising, opposite the free end 32, a locking end 341. At the locking end 341, the stem 34 comprises a reversible series of locking balls 35 arranged so as to be able to be displaced in a radial manner centripetally under the effect of pressure on the mobile unlocking control button 33 situated at the free end 32 of the locking broach 30 of the device for securing a connection 1 according to the invention.

The locking pin 31 is, here in this embodiment of the locking broach 30, permanently, but reversibly, screwed into the introduction orifice 11, an external threading 311 provided for this purpose on the locking pin 30 cooperating with the threading of the introduction orifice 11. The locking pin 31 further comprises a female impression 312 for its placement in the introduction orifice 11. The locking pin 31 also comprises a coaxial receiving channel 313, passing longitudinally through the locking pin 31. The receiving channel 313 comprises a locking groove 314 arranged so as to receive, upon locking, the reversible series of locking balls 35 in order to hold the locking end 341 of the stem 34 of the locking broach 30 in place, once the locking end 341 is introduced into the receiving channel 313.

In a variant embodiment, the locking pin 31 is made of a piece with the first element 10 of the device for securing a connection 1 according to the invention, the introduction orifice 11 comprising the receiving channel 313 and the locking groove 314. Thus, the locking pin 31 and the first element 10 form a single one-piece part, which can be produced in different ways that are known per se by the person skilled in the art: machining, three-dimensional printing, molding, etc., from materials such as aluminum, thermoplastics, etc.

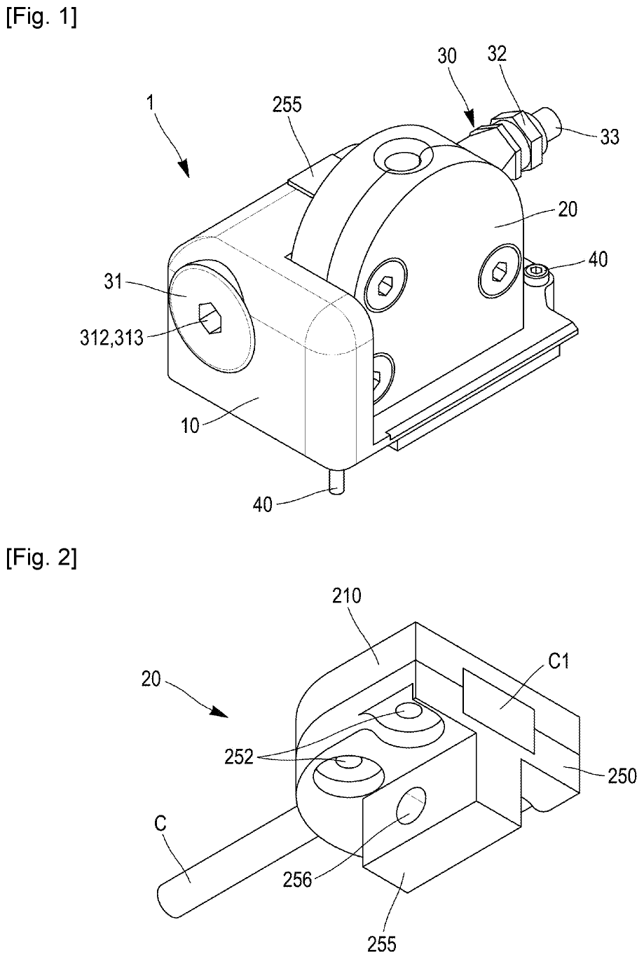

Referring to FIGS. 2, 5 and 6a, 6b, there now follows a description of the second element 20 of the device for securing a connection 1 according to the invention.

In the embodiment presented here, the second element 20 comprises a cap 210 and a support 250, the cap 210 and the support 250 being arranged so as to be assembled with one another to form the second element 20 of the device for securing a connection 1 according to the invention.

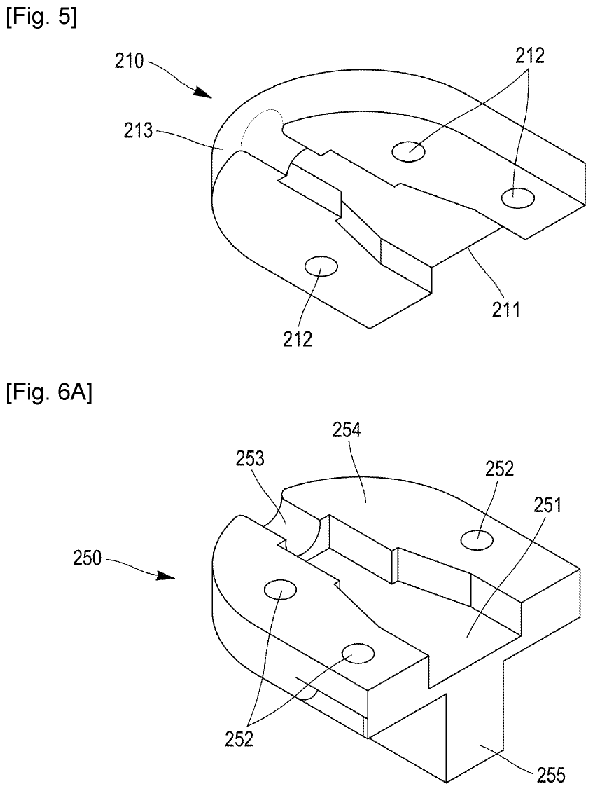

The cap 210 is illustrated in more detail in FIG. 5. The cap 210 takes the form of a plate in which a top housing 211 is formed for the connection tip C1 which is longitudinal extended with a top passage 213 for a data transfer cable C associated with the connection tip C1 that is intended to be received in the top housing 211. Also, the cap 210 comprises a series of fixing holes 212 passing through a thickness of the plate forming the cap 210.

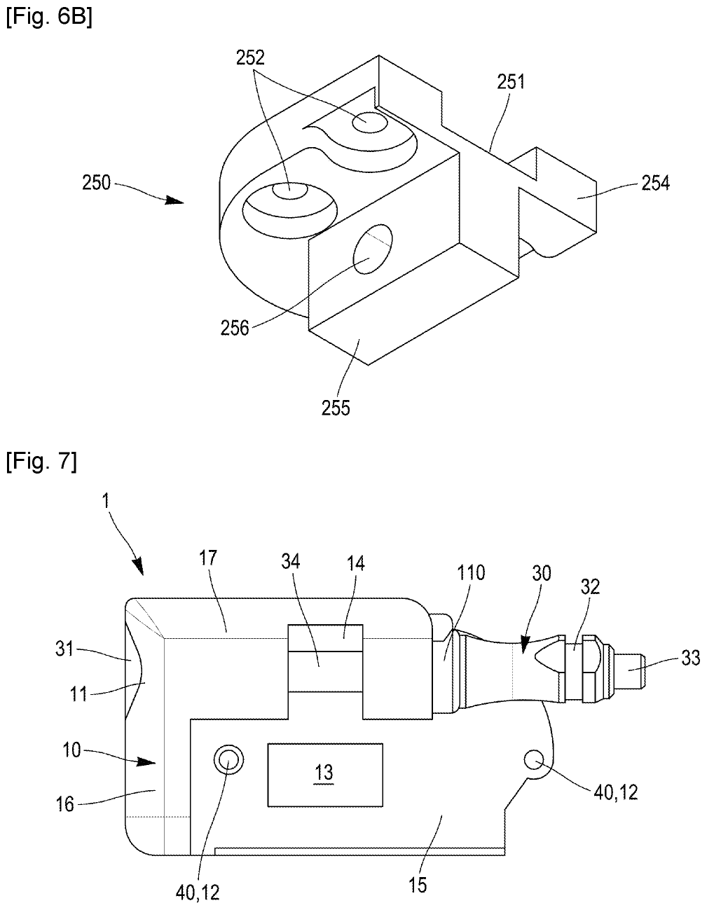

Referring to FIGS. 6a and 6b, there now follows a more detailed description of the support 250 of the second element 20 of the device for securing a connection 1 according to the invention. In a way similar and symmetrical to the cap 210 previously described, the support 250 comprises a base 254 in which are formed a bottom housing 251 for the connection tip C1 and a bottom passage 253 for the data transfer cable C associated with the connection tip C1, extended longitudinally with the bottom housing 251. As previously, the base 254 of the support 250 comprises a series of fixing passages 252 intended to be positioned opposite the fixing holes 212 of the cap 210 when the latter is assembled with the support 250, as will be explained a little later. On a bottom face of the base 254 of the support 250, the support 250 comprises a protuberance 255 extending from the bottom face of the base 254. This protuberance 255 has a form complementing the receiving groove 14 of the first element 10 of the device for securing a connection 1 according to the invention. The protuberance 255 comprises a locking through orifice 256.

An assembly of the cap 210 on the support 250 is illustrated in FIG. 2 in which the connection tip C1 of a data transfer cable C is received securely in the top 211 and bottom 251 housinges of the second element 20. In FIG. 2, the protruding and useful part of the connection tip C1 is not represented: it extends protrudingly from the housing produced by the top 211 and bottom 251 housinges of the second element 20.

Also, the data transfer cable C emerges through the top 213 and bottom 253 passages formed for this purpose in the cap 210 and the support 250 of the second element 20 of the device for securing a connection 1 according to the invention. Thus, once assembled on the connection tip C1, the second element simply and reliably holds this connection tip C1 in the top 211 and bottom 251 housinges which have, here, a form complementing this connection tip C1. This assembly can for example be produced by fixing screws passing initially through the fixing passages 252 formed in the support 250 to engage, by threading for example, in the fixing holes 212 of the cap 210. A reverse arrangement of this assembly is possible: the fixing screws passing initially through the fixing holes 212 formed in the cap 210 to engage, by threading for example, in the fixing passages 252 of the support 250.

A second element 20 has been described which, here, is added on and produced in two parts around the connection tip C1 of the data transfer cable C. In a variant embodiment, the cap 210 and the support 250 form a single part made of a piece with one another, a part which is then overmolded around the connection tip C1 of the data transfer cable C. In another variant embodiment, the connection tip C1 is formed by the second element 20 directly. That makes it possible to provide a data transfer cable C that is already equipped with the second element 20 of the device for securing a connection 1 according to the invention.

A use of the device for securing a connection 1 according to the invention will now be described. Initially, the second element 20 is assembled on the connection tip C1 of a data transfer cable C, by imprisoning the connection tip C1 in the top housing 211 of the cap 210 and the bottom housing 251 of the support 250 of the second element 20. In parallel, the first element 10 is put in place on the mobile device using the fixing means 40 (the position and the format of the fixing means 40 are adapted to what is provided by the manufacturer of the mobile device targeted) such that the passage 13 of the connection tip is opposite the complementary connection receiver of the connection tip formed on the mobile device to which the first element 10 of the device for securing a connection 1 according to the invention is fixed. Next, the second element 20 is assembled with the first element 10 by making the protuberance 255 cooperate with the receiving groove 14, the guiding wall 17 coming to bear on a bottom face of the base 254 on either side of the protuberance 255 and the lateral wall 16 coming to bear on a lateral face of the cap 210 and support 250. Once the second element 20 is positioned on the first element 10, the locking through orifice 256 is then opposite the introduction 11 and receiving 110 orifices of the first element 10. Thus, the locking broach 30, in particular the stem 34, simply has to be placed through all of the introduction 11, locking through 256 and receiving 110 orifices, as is illustrated in FIGS. 1 and 7. The threading formed in the introduction orifice 11 cooperates with the complementary threading 311 of the locking pin 31 and the reversible series of locking balls 35 extends in the locking groove 314, so as to durably and simply secure the assembly of the first element 10 with the second element 20, the connection tip C1, at least the protruding and useful part of the connection tip C1, being received in the complementary connection receiver of the mobile device to which the device for securing a connection 1 according to the invention and previously described is securely and removably fixed.

The data transfer cable C can be a cable of USB (universal serial bus) type or else any other cable for transferring data such as audio, light or other information. The application is not limited to use with a professional digital camera but extends to any mobile device of camera, portable music player or other type, requiring or involving more or less frequent manipulations and above all requiring the connection between the connection tip C1 of the data transfer cable C with the complementary connection receiver of the mobile device with which the connection is made to be made durable.

Obviously, many modifications can be made to the invention without in any way departing from the scope thereof.

1. A securing device for securing a connection of a connection tip with a receiver of complementary connection of a mobile device, the device comprising a first element arranged so as to be secured removably to the mobile device in the vicinity of the connection receiver, and a second element arranged so as to be secured to the connection tip, characterized in that the securing device comprises means for securely assembling the first and second elements with one another, when a connection is made between the connection tip and the receiver.

2. The securing device as claimed in claim 1, wherein one of the first and second elements comprises a groove for receiving all or part of the other of the first and second elements.

3. The securing device as claimed in claim 2, wherein the other of the first and second elements comprises a protuberance of a form complementing a form of the receiving groove.

4. The securing device as claimed in claim 1, wherein the secured assembly means comprise a locking pin.

5. The securing device as claimed in claim 4, wherein one of the first and second elements comprises a groove for receiving all or part of the other of the first and second elements and wherein the locking pin is arranged so as to pass through the receiving groove.

6. The securing device as claimed in claim 5, wherein the other of the first and second elements comprises a protuberance of a form complementing a form of the receiving groove and wherein the locking pin is arranged so as to pass through the protuberance of complementary form.

7. (canceled)

8. The securing device as claimed in claim 1, wherein the second element is overmolded on the connection tip.

9. The securing device as claimed in claim 1, wherein characterized in that the second element forms the connection tip, made of a piece therewith.

10. A secured connection kit comprising a cable comprising a connection tip, further comprising the securing device as claimed in claim 1, the second element being mounted on the connection tip.

11. (canceled)
